(19) United States
(12) Patent Application Publication
(10) Pub. No.: US 2005/0058784 A1
(43) Pub. Date: Mar. 17, 2005

(54) Ink-jet recording medium, production method thereof, and ink-jet image forming method

(75) Inventor: Makoto Kaga, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Holdings, Inc., Tokyo (JP)

(21) Appl. No.: 10/935,049

(22) Filed: Sep. 7, 2004

(30) Foreign Application Priority Data
Sep. 17, 2003 (JP) JP2003-324261

(51) Int. Cl. B41M 5/00

(52) U.S. Cl. 428/32.24

(57) ABSTRACT

An ink-jet recording medium comprising: a non water-absorbing substrate; one or more ink receiving layers provided on the substrate, and a surface layer provided on the ink receiving layer; wherein the ink receiving layer is a porous layer containing a cross-linked polymer as a binder formed by irradiation of ionizing radiation to a hydrophilic polymer having a polymerization degree of at least 300 and a plurality of side chains on a main chain so as to cross-link the hydrophilic polymer through side chains; and the surface layer is a porous layer containing the cross-linked polymer as a binder and a cationic colloidal silica.

### FIELD OF THE INVENTION

The present invention relates to an ink-jet recording medium, and more specifically to an ink-jet recording medium which exhibits high glossiness, high ink absorbability and enhanced resistance to cracking due to folding, and a production method thereof, and an ink-jet image forming method for excellent image storage stability.

### BACKGROUND OF THE INVENTION

In recent years, regarding ink jet recording systems, image quality has increasingly been improved and is approaching that of conventional silver salt photography. However, of the porous layer media employing mainly microscopic inorganic pigment particles to improve ink absorbability, ink-jet recording media employing silica is advantageous in cost and exhibits low surface glossiness, but is inferior in quality to conventional silver salt photography. Further, degradation of image storage stability caused by resolving of colorants by ozone gases, for which various technologies have been disclosed, but in actual situations, the quality is still inferior to that of silver salt photography.

As an image quality enhancing technology, is one which incorporates colloidal silica on an ink-jet recording medium containing inorganic pigment particles (being described in, for example, Patent Documents 1-3). Properties of coloring, ink absorbability and resistance to water are enhanced with these technologies, but still not sufficiently for the simultaneous attainment of glossiness and ink absorbability.

Further, in cases when colloidal silica is solely employed, degradation of image quality becomes problematic due to flaking of colloidal silica after drying due to insufficient adhesiveness at the lower layer, and film layer strength. To solve these problems, a hydrophilic polymer binder may be added to colloidal silica to enhance layer strength, however, in lowering of ink absorption rate.

Further, a colloidal silica solution exhibits lower viscosity compared to a coating composition of an ink absorbing layer comprising inorganic pigment micro-particles. Therefore, when these are simultaneously multilayer coated, degradation of surface glossiness and cracking during coating, caused by interlayer mixture of both layers becomes problematic.

On the contrary, as a means to improve image storage penetration of ozone gases by covering the image surface with microscopic polymer particles after deposition of ink on the ink-jet recording medium, in which ink water dispersible microscopic polymer particles are added (being described in, for example, Patent Document 4).

Image forming by ink ejection is conducted by providing a plurality of ink droplets sequentially on the same location of the medium. In the case of a dye ink containing water dispersible microscopic polymer particles, in cases when, after the initial ink droplet deposition, the water dispersible microscopic polymer particles contained in the ink adhere to and form a film on the ink-jet recording medium, and when the second droplet is deposited, the ink absorption rate of the recording medium is significantly decreased resulting in problems of image quality degradation of irregular dot shapes, color mixing of different colors and mottling. For these reasons, desired is an ink-jet recording medium having a high ink absorbability.

Providing a colloidal silica layer to enhance glossiness results in substantial degradation of the ink absorption rate. So far, there has been no technology to satisfy the three criteria of high glossiness, high ink absorption rate and excellent image storage stability.

As for a binder which affects the ink absorption rate, a recording medium for aqueous ink having an ink absorbing layer comprising a hydrophilic resin cross-linked by ionizing radiation is disclosed, in addition to a technology using a usual hydrophilic polymer such as polyvinyl alcohol (being described in, for example, Patent Document 5). By using a cured binder in an ink absorbing layer, water resistance of images and film layers is enhanced, however, ink absorption is not improved (in fact, being rather degraded) because the ink is largely absorbed by the swelling of the resin.

Contrary to the foregoing, ink-jet recording sheets which absorb ink utilizing swelling property of a hydrophilic resin, a recording sheet comprising a porous layer having minute voids as an ink absorbing layer exhibits sufficient ink absorbability as well as sufficient drying capability. The use of the above recording sheet is becoming one of the methods which produce prints exhibiting image quality closest to conventional photography (being described in, for example, Patent Document 6).

On the other hand, there is an example of applying an ink absorbing layer containing a hydrophilic resin cross-linked by ionizing radiation for a porous type ink-jet recording sheet having a porous layer including pores (being described in Patent Document 7). In said document, proposed is a method for forming an ink absorbing layer in which a coating composition, comprised mainly of an inorganic sol and a monomer/oligomer, curable by ionizing radiation, is coated and the monomer/oligomer is hardened by ionizing radiation after which the coated layer is dried. However, the coated layer which is constituted of a relatively high density and three dimensional linkages employing ethylenic double bonds is hard and brittle, and resistance to cracking of the layer is low.

Further, the monomers/oligomers curable by ionizing radiation generally have relatively low molecular weight and include many which are toxic to human skin. Moreover, unreacted free radicals, a polymerization initiator or a polymerization inhibitor, remaining in the coated layer, break or decompose polymer chains so that resistance to breaking by folding of the coated layer is degraded during the storing period.

Furthermore, almost all the monomers/oligomers curable by ionizing radiation available on the market have low hydrophilicity making them unsuitable for general coating employing an aqueous system coating composition as the method of forming the ink absorbing layer on ink-jet recording sheets. Accordingly, a problem is raised in that the allowable range of employable materials is extremely narrow.

Patent Document 1: Unexamined Japanese Patent Application Publication (hereinafter, referred to as JP-A) No. 2001-353957

Patent Document 2: JP-A 2002-274021

Patent Document 3: JP-A 2003-94800

Patent Document 4: JP-A 2001-187852

Patent Document 5: JP-A 1-286886

Patent Document 6: JP-A 10-119423

Patent Document 7: JP-A 9-263038

### SUMMARY OF THE INVENTION

An object of the present invention is to provide an ink-jet recording medium which exhibits high glossiness, high ink absorbability and enhanced resistance to cracking by folding, and a production method thereof, and an ink-jet image forming method for slight glossiness differences between printed areas and unprinted areas, as well as excellent image storage stability and resistance to abrasion.

The present-invention was achieved employing the following embodiments.

Item 1. An ink-jet recording medium comprising:
(i) a non water-absorbing substrate;
(ii) one or more ink receiving layers provided on the substrate; and
(iii) a surface layer provided on the ink receiving layer;
   wherein the ink receiving layer is a porous layer containing a cross-linked polymer as a binder formed by irradiation of ionizing radiation to a hydrophilic polymer having a polymerization degree of at least 300 and a plurality of side chains on a main chain so as to cross-link the hydrophilic polymer through side chains; and the surface layer is a porous layer containing the cross-linked polymer as a binder and a cationic colloidal silica.

Item 2. The ink-jet recording medium of claim 1, wherein the ink receiving layer further contains inorganic pigment micro-particles, and a weight ratio of inorganic pigment micro-particles to the binder, both being contained in the ink receiving layer, is in the range of 3:1 to 30:1.

Item 3. The ink-jet recording medium of claim 1, wherein a weight ratio of the cationic colloidal silica to the binder, both being contained in the surface layer is in the range of 3:1 to 30:1.

Item 4. A production method of an ink-jet recording medium comprising the steps of:
(i) providing on a non water-absorbing substrate, one or more ink receiving layers containing a cross-linked polymer formed by irradiation of ionizing radiation to a hydrophilic polymer compound which has a polymerization degree of at least 300 and a, plurality of side chains on a main chain so as to cross-link through the side chains; and
(ii) providing a surface layer containing a cationic colloidal silica on the ink receiving layers;
wherein a coating composition of the ink receiving layer adjacent to the surface layer contains a gas phase method silica; and
the one or more ink receiving layers and the surface layer are provided using a simultaneous multilayer coating method.

Item 5. The production method of the ink-jet recording medium of claim 4, wherein a weight ratio of inorganic pigment microparticles to the binder, both being contained in the ink receiving layer, is in the range of 3:1 to 30:1.

Item 6. The production method of the ink-jet recording medium of claim 4, wherein a weight ratio of the cationic colloidal silica to the binder, both being contained in the surface layer, is in the range of 3:1 to 30:1.

Item 7. An ink-jet image forming method comprising the step of:
recording an ink-jet image onto the ink-jet recording medium of claim 1, using a water-soluble dye ink which contains microscopic water dispersible polymer particles.

### DETAILED DESCRIPTION OF THE INVENTION

According to the present invention, provided is an ink-jet recording medium which exhibits high glossiness, high ink absorbability and enhanced resistance to cracking by folding, and a production method thereof, and an ink-jet image forming method showing only slight glossiness differences between printed areas and unprinted areas, and excellent image storage stability and resistance to abrasion.

The inventors of the present invention conducted diligent investigation in view of the foregoing problems, resulting in finding an ink-jet recording medium which is superior in ink absorbability, cracking resistance during coating, cracking by folding, and glossiness in white backgrounds, employing an ink-jet recording medium comprising a nonabsorbable substrate, a polymer compound being contained as a binder thereon, and at least one ink absorbing layer, comprised of a porous layer, of which the outermost layer, from the substrate, contains a cationic colloidal silica, wherein the polymer compound is formed by irradiation of ionizing radiation to the hydrophilic polymer compound which has a plurality of side chains on a main chain, to promote generation of cross-linking bonds through the side chains, and has a polymerization degree of at least 300, whereby the inventors achieved the present invention.

An ink-jet recording medium (hereinafter, referred to simply as a recording medium) of the present invention will be described below.

In the present invention, “a polymer compound cross-linked through side chains to each other” is a polymer compound obtained by irradiation of ionizing radiation onto a hydrophilic polymer having a plurality of side chains on the main chain, to be described later, and a polymerization degree of at least 300.

In this invention, “a hydrophilic polymer compound cross-linked through side chains having a plurality of side chains on the main chain and a polymerization degree of at least 300” is a polymer compound having a polymerization degree of at least 300, and through which side chains are cross-linked with each other when the ionizing radiation is radiated onto the polymer compound.

The main chain of the polymer compound is preferably constituted by at least one selected from the group of (a) a saponification product of vinyl acetate, (b) polyvinyl acetal, (c) polyethylene oxide, (d) polyalkylene oxide, (e) polyvinylpyrrolidone, (f) polyacrylamide, (g) hydroxyethyl cellulose, (h) methyl cellulose, (i) hydroxypropyl cellulose, (j) at least one derivative of foregoing (a)-(i), and (k) a copolymer containing (a)-(j). These polymer compounds are preferably resins capable of being converted more insoluble in water after cross-linking by the irradiation of the ionizing radiation such as ultraviolet rays or electron rays, than before cross-linking.

Further, the side chain is preferably constituted by a modifying group selected from the groups such as a photo-dimerizable type, a photo-decomposable type, a photo-polymerizable type, a photo-modifying type and a photo-depoly merizable type. Such side chains are preferably formed by modifying the main chain of at least one kind of the foregoing (a)-(k) Polymerization initiators and polymerization inhibitors are essentially not necessary for forming the cross-linking of the hydrophilic polymer compound having plural side chains on the main chain thereof and a polymerization degree of at least 300 to be used in the invention, and the formation of unreacted free radicals after the irradiation of the ionizing radiation can be also inhibited. Therefore, the degradation of cracking due to folding (i.e. fissures by folding) during storage can be inhibited.

Further, the network structure of the porous layer of this invention can easily hold many fine particles since such a layer contains the binders containing the polymer compound formed by cross-linking through the side chains by irradiating of the ionizing radiation to the hydrophilic polymer compound having plural side chains on the main chain thereof and a polymerization degree of at least 300 which has a long distance cross-linkage differing from the relatively short distance cross-linkage of the three dimensional structure in the porous network formed by cross-linking by only using the polymerization initiator, or that formed by cross-linking by irradiation of the ionizing radiation to a hydrophilic polymer compound having no plural side chains, or a polymer compound having a lower polymerization degree. Consequently, a uniform porous layer can be formed by a smaller amount of the binder, namely by a smaller ratio of the binder to the amount of the microscopic particles. The void ratio (i.e. the ratio of pore spaces) in the ink-jet recording layer can be raised and the ink is more easily held in the layers when the ratio of the binder to the microscopic particles is small. Accordingly, ink saturation can be prevented. Thus an ink-jet recording medium having a porous layer can be obtained, which can be rapidly dried and has, a tough coated layer and high resistance to cracking during folding. Further, the porous layer has high resistance to cracking and peeling and to stress caused by folding before and after printing of images.

Therefore, an ink-jet recording medium can be obtained which has high ink absorbability and improved resistance to water and reduced occurrence of cracks caused by folding.

It is preferable that the hydrophilic polymer compound having a plurality of side chains on the main chain is a photo-dimerizable diazo type compound or one introduced with a cinnamoyl group, a stilbazolinium group or a styrylquinolinium group.

Further, preferred are resins which are dyed with water-soluble dyes such as anionic dyes, after photo cross-linking. Listed as such resins are, for example, those having a cationic group such as a primary amino group or a quaternary ammonium group, photosensitive resins (being compositions) described, for example, in JP-A Nos. 56-67309, 60-129742, 60-252341, 62-283339, and 1-198615, resins having a group such as an azido group which is converted to an amino group through a curing treatment, and thereby becoming cationic, and photosensitive resins (being compositions) described, for example, in JP-A 56-67309.

Specifically listed are the following compounds.

In the present invention, preferably employed are photosensitive resins described in JP-A 56-67309. The foregoing resins include resin compositions having a 2-azido-5-nitrophenylcarbonyloxyethylene structure represented by Formula (1), described below, or a 4-azido-3-nitrophenylcarbonyloxyethylene structure represented by Formula (2), also described below, in a polyvinyl alcohol structure.

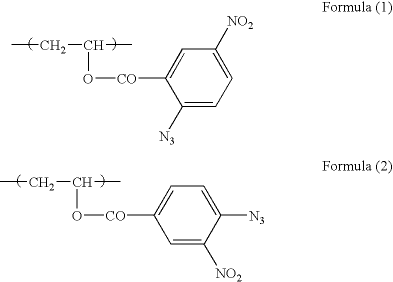

Specific examples of the foregoing resins are described in Examples 1 and 2 of the foregoing patent document, while constitution components and their ratio are described on page 2 thereof.

Further, JP-A 60-129742 describes photosensitive resins which include polyvinyl alcohol based resins having the structural units represented by Formula (3) or (4), shown below, in the polyvinyl alcohol structure; 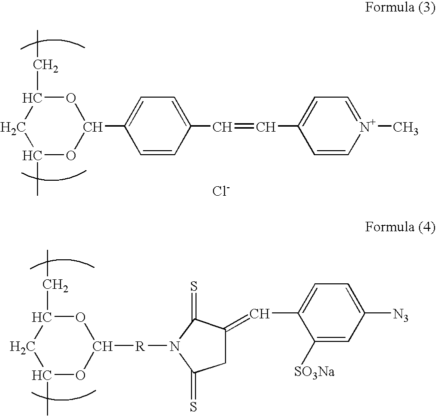
wherein R₁ is an alkyl group of 1-4 carbon atoms, and A⁻ is an anion. These are polyvinyl alcohol based resins having structural units comprising a styrylpyridinium (stilbazolinium) structure or a styrylquinolinium structure, which are prepared by allowing polyvinyl alcohol or partially saponified polyvinyl acetate to react with a styrylpyridinium salt or a styrylquinolinium salt. The production methods of these are described in detail in JP-A 60-129742 and are easily produced with reference to the foregoing patent publication.

The ratio of a styrylpyridinium group or a styrylquinolinium group in polyvinyl alcohol having the styrylpyridinium group or the styrylquinolinium group is preferably 0.2-10.0 mol % per polyvinyl alcohol unit. When the ratio is at most 10.0 mol %, solubility in the coating composition may be enhanced. Further, when at least 0.2 mol %, strength after cross-linking is enhanced.

Further, in the foregoing, polyvinyl alcohol used as a main component may contain acetyl groups which are not partially saponified, and the content of the acetyl group is preferably less than 30%. The degree of polymerization thereof is preferably about 300-3,000, and more preferably 400 or more. When the degree of polymerization is more than 300, it is possible to decrease the irradiation time for curing, resulting in increased productivity. Further, when the degree of polymerization is at most 3,000, it is possible to inhibit a viscosity increase, resulting in easier handling.

The following hydrophilic resin may be used in the porous layer, in the cationic colloidal silica layer or in both layers as the binder, together with polymer compounds having the plural side chains on the main chain thereof and a polymerization degree of at least 300, as long as such resin does not degrade the properties of the object of this invention.

Hydrophilic binders additionally incorporated are not particularly limited, and any of those known in the art as hydrophilic binders may be employed. For example, employed may be gelatin, polyvinylpyrrolidone, polyethylene oxide, polyacrylamide, and polyvinyl alcohol. Of these, polyvinyl alcohol is particularly preferred.

Polyvinyl alcohol exhibits an interaction with inorganic microparticles resulting in a high holding power of the inorganic microparticles. Further, polyvinyl alcohol is a polymer whose hygroscopic properties exhibits a relatively small dependence on humidity, and whose contraction stress during coating and drying is also relatively small. As a result, polyvinyl alcohol is preferred for minimizing cracking during coating and drying, which is one of the problems to be solved by the present invention. Polyvinyl alcohol preferably employed in the present invention includes common polyvinyl alcohol which is prepared by hydrolyzing polyvinyl acetate, and also modified polyvinyl alcohol such as polyvinyl alcohol whose terminals have been subjected to cation modification, and anion-modified polyvinyl alcohol having an anionic group.

The average polymerization degree of polymerization of the polyvinyl alcohol prepared by hydrolyzing vinyl acetate is preferably at least 300, but is more preferably 1,000-5,000. The saponification ratio of the polyvinyl alcohol is preferably 70-100%, but is more preferably 80-99.5%.

The cation-modified polyvinyl alcohol includes, for example, polyvinyl alcohol which has a primary, secondary or tertiary amino group, or a quaternary ammonium group in the main or side chain of the polyvinyl alcohol, as described in JP-A 61-10483. The polyvinyl alcohol is prepared by saponifying the copolymer of an ethylenic unsaturated monomer, having a cationic group, and vinyl acetate.

The weight ratio of microscopic particles to the hydrophilic binders of the porous layer is preferably 3:1-30:1. When the weight ratio is at less 3:1, the desired void ratio of the porous layer is obtained. As a result, it is possible to easily obtain the sufficient void volume. In addition, it is possible to reduce excessive hydrophilic binders swelling during ink jet recording and blocking of voids (i.e. the space of pores). On the other hand, when the ratio is at most 30:1, undesirable cracking, which tends to occur during coating of a relatively thick porous layer, is advantageously reduced. The weight ratio of microparticles and the hydrophilic binders is preferably 6:1-15:1 in view of avoiding cracking of the dried layer by folding.

In this invention, the microscopic particles in the porous layer form the spacing of pores, together with the polymer compound formed by cross-linking through the side chains of the hydrophilic polymer compound having plural side chains on the main chain thereof and a polymerization degree of at least 300 by irradiation of the ionizing radiation. As the microscopic particles to be contained in the porous layer, inorganic microparticles or organic microparticles may be employed, however, inorganic microparticles are preferably employed since still smaller particles can be easily obtained, and recording paper with high glossiness and a high density printed image can be achieved.

Listed as said microscopic inorganic particles may, for example, be white inorganic pigments such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, and magnesium hydroxide. Primary microscopic inorganic particles may be employed without any further modification, and inorganic particles may also be employed as secondary coagulated particles.

In this invention, from the viewpoint of preparing high quality prints utilizing ink jet recording paper sheets, preferred as microscopic inorganic particles are alumina, pseudo-boehmite, colloidal silica, and microscopic silica particles synthesized employing a gas phase method. Of these, fine silica particles, synthesized by employing a gas phase method are specifically preferred. Also the silica synthesized by employing a gas phase method, whose surface is modified with aluminum may also be employed. The content ratio of aluminum in the gas phase method silica whose surface is modified with aluminum is preferably 0.05-5% by weight with respect to the total silica.

The diameter of the above microscopic particles is not specifically limited, however, the average diameter is preferably not more than 4 μm. When said diameter is preferably at most 4 μm, excellent glossiness as well as color forming properties result. Therefore, the diameter is more preferably at most 0.2 μm, but is most preferably at most 0.1 μm. The lower limit of the diameter is not specifically limited, however, from the viewpoint of producing microscopic particles, the lower limit is preferably at least approximately 0.003 μm, and is more preferably at least 0.005 μm.

The average diameter of the microscopic particles is obtained as follows. The cross-section and surface of a porous layer are observed employing an electron microscope, and the diameters of 100 randomly selected particles are determined. Then, the average diameter is obtained as a simple average (being a number average), based on the obtained data. Herein, each particle diameter is the diameter of a circle which has the same area as the equivalent projection area of each particle.

Further, from the viewpoint of glossiness as well as color forming properties, the degree of dispersion of the microscopic particles in the porous layer is preferably at most 0.5. When the degree of dispersion is at most 0.5, the resulting sufficient glossiness as well as color forming properties of the printed image are obtained. The degree of dispersion is most preferably at most 0.3. The degree of dispersion of microscopic particles, as described herein, refers to the value obtained by dividing the standard deviation of the particle diameter by the average particle diameter, which is determined by observing the microscopic particles of the porous layer using an electron microscope, in the same manner as for determining the foregoing average particle diameter.

The microscopic particles may be located in the porous layer in the form of primary particles which are not subjected to any modification, or in the form of secondary particles, or higher order coagulated particles. However, the average particle diameter refers to the average diameter of particles which form independent particles in the porous layer when observed with an electron microscope, that is, the highest-order particles in the porous layer.

The content of the microscopic particles in the water-soluble coating composition for forming the porous layer is preferably 5-40 weight %, and is more preferably 7-30 weight %.

Various types of additives may be incorporated into the water-soluble coating composition which forms the porous layer. Listed as such additives are, for example, cationic mordants, cross-linking agents, surface active agents (being cationic, nonionic, anionic, or amphoteric), background color modifiers, fluorescent brightening agents, antiseptics, viscosity modifiers, low-boiling-point organic solvents, high-boiling-point organic solvents, latex emulsions, anti-discoloring agents, UV absorbing agents, multivalent metallic compounds (being water-soluble or water-insoluble), matting agents, and silicone oil. Of these, cationic mordants are preferred since they enhance water resistance as well as moisture resistance.

Employed as the cationic mordants are polymer mordants having a primary, secondary, or tertiary amino group, or a quaternary ammonium salt group. Of these, polymer mordants having a quaternary ammonium salt group are preferred, which result in minimal discoloration as well as minimal degradation of light resistance during storage, and also exhibit sufficiently high mordant capability in dyes.

The preferred mordants are prepared as either homopolymers of monomers having a quaternary ammonium salt group or copolymers, and condensation polymers of the monomers with other monomers.

Further, it is specifically preferred to incorporate cross-linking agents of the hydrophilic binders into the porous layer, or to overcoat binder onto the dried porous layer. By employing the cross-linking agents, the water resistance of the porous layer is further enhanced, and in addition, the ink receiving rate is also enhanced during ink jet recording due to the fact that the swelling of the hydrophilic binders is reduced.

Any cross-linking agents well known in the art may be employed, which include inorganic cross-linking agents (such as chromium compounds, aluminum compounds, zirconium compounds, and boric acids), and organic cross-linking agents (such as epoxy based cross-linking agents, isocyanate based cross-linking agents, aldehyde based cross-linking agents, N-methylol based cross-linking agents, acryloyl based cross-linking agents, vinyl sulfone based cross-linking agents, active halogen based cross-linking agents, carbodiimide based cross-linking agents, and ethyleneimino based cross-linking agents). The content ratio of these cross-linking agents is commonly about 1-50 weight % with respect to the hydrophilic binders, and is preferably 2-40 weight %.

When the hydrophilic binders are comprised of polyvinyl alcohols and the microscopic particles are comprised of silica, specifically preferred as cross-linking agents are inorganic cross-linking agents containing elements of Group III or IV in Periodic Table, specifically being boric acids and zirconium compounds, as well as epoxy based cross-linking agents.

In the present invention, multivalent metal compounds may be employed by addition in the porous layer mentioned above.

Employed as such multivalent metallic compounds are sulfates, chlorides, nitrates, and acetates of Mg²⁺, Ca²⁺, Zn²⁺, Zr²⁺, Ni²⁺, and Al³⁺. Incidentally, examples of preferred water-soluble multivalent metallic compounds include inorganic polymer compounds such as basic polyaluminum hydroxide and zirconyl acetate. By adding at least one of the multivalent metallic compounds into the porous layer, it is possible to reduce bleeding and to enhance water resistance. The content of these water-soluble multivalent metal ions in the porous layer is preferably in the range of about 0.05-20 millimoles per m² of the recording medium, and is preferably in the range of 0.1-10 millimoles.

“Cationic colloidal silica” of this invention is colloidal silica which has a cationic surface, which can be obtained by modification of colloidal silica surface with a compound having a cationic group, or by modification with addition of specific compound, during formation of colloidal silica. Colloidal silica is silicon dioxide which is dispersed to become colloidal, and is spherical exhibiting a primary particle diameter of around 9-100 nm. Examples of these colloidal silica include the Snowtex series of Nissan Chemical Industries, Ltd., the Cataloid-S series of Catalysis & Chemicals Ind. Co., Ltd., and the Levasil series of Bayer AG.

Examples of methods to obtain the cationic colloidal silica are:
(1) the surface of colloidal silica is treated with a silan coupling agent or a titanium coupling agent which features a cationic group;
(2) the surface of colloidal silica is made to react with a monomer having a cationic group to coat the surface with a colloidal polymer;
(3) the surface of colloidal silica is coated with a polymer which has a cationic group; and
(4) the surface of colloidal silica is made to be cationic by introducing aluminum atoms into the colloidal silica coexisting in a compound containing aluminum atoms during formation of the colloidal silica.

In this invention, preferably employed is a cationic colloidal silica prepared by method (4) above.

As the substrate of the ink-jet recording medium of the invention, a non-water absorbing substrate may preferably be used from the viewpoint of obtaining high quality prints.

Non-water absorbing substrates capable of being preferably employed in the present invention include transparent substrates as well as opaque supports. Listed as such substrates are films comprised of materials such as polyester resins, diacetate resins, triacetate resins, polyolefin resins, acrylic based resins, polycarbonate based resins, polyvinyl chloride based resins, polyimide based resins, cellophane, and celluloid. Or, employed may be resin coated paper (being so-called RC paper) in which both sides of the base paper is covered with a polyolefin resin layer.

For the purpose of enhancing adhesion between the surface of the various substrates and the coating layer, it is preferable that prior to coating of the foregoing water soluble coating composition, the substrates are subjected to a corona discharge treatment, as well as being subjected to a subbing treatment. Further, in this invention, the substrates may be tinted.

Preferable examples of the substrates of this invention are a transparent polyester film, an opaque polyester film, an opaque polyolefin resin film and a paper substrate laminated on both sides with a polyolefin resin.

The most preferable paper substrate laminated with polyethylene, being a typical polyolefin, will now be described.

Base paper, employed in the paper substrates, is made employing wood pulp as the main raw material, and if desired, together with a synthetic pulp such as polypropylene or a synthetic fiber such as nylon and polyester. Employed as the wood pulp may be any of LBKP, LBSP, NBKP, NBSP, LDP, NDP, LUKP, or NUKP. It is preferable that LBKP, NBSP, LBSP, NDP, and LDP, which contain shorter fibers, are employed in a greater amount. However, the content of LBSP or LDP is preferably 10-70 weight %.

Preferably employed as the pulp is a chemical pulp (being sulfate pulp and sulfite pulp), due to fewer impurity. Further, also useful is a pulp which has been subjected to a bleach treatment to increase whiteness.

Incorporated into the base paper, may be suitable sizing agents such as higher fatty acids and alkylketene dimers; white pigments such as calcium carbonate, talc, and titanium oxide; paper strength enhancing agents such as starch, polyacrylamide, and polyvinyl alcohol; fluorescent brightening agents; moisture maintaining agents such as polyethylene glycols; dispersing agents; and softeners such as quaternary ammonium salts.

The degree of water freeness of the pulp employed for paper making is preferably 200-500 ml under CSF Specification. Further, the sum weight % 24-mesh residue and weight % of 42-mesh residue of calculated portions regarding the fiber length after beating, specified in JIS-P-8207, is preferably 30-70 weight %. Further, the weight percent of 4-mesh residue is preferably 20 weight % or less.

The weight of the base paper is preferably 30-250 g/m², but is specifically preferably 50-200 g/m², which the thickness of the base paper is preferably 40-250 μm. During or after the paper making stage, the base paper may be subjected to a calendering treatment to result in better smoothness. The density of the base paper is generally 0.7-1.2 g/m³ (being defined in JIS-P-8118), while, the stiffness of the same is preferably 20-200 g under the conditions specified in JIS-P-8143. Surface sizing agents may also be applied onto the base paper surface. Employed as the surface sizing agents may be the same as those above, if capable of being incorporated into the base paper. The pH of the base paper, when determined employing a hot water extraction method specified in JIS-P-8113, is preferably 5-9.

Polyethylene, which is employed to laminate both surfaces of the base paper, is mainly comprised of low density polyethylene (LDPE) or high density polyethylene (HDPE). However, other LLDPE's or polypropylene may be partially employed.

Specifically, as is generally done with photographic paper, the polyethylene layer located on the coated layer side is preferably constituted employing polyethylene into which rutile or anatase type titanium oxide is incorporated, whereby opacity as well as whiteness is improved. The content ratio of the titanium oxide to polyethylene is generally 1-20 weight %, but is more preferably 2-15.

It is possible to employ polyethylene coated paper as glossy paper. Further, in the present invention, it is possible to employ polyethylene coated paper with a matt or silk surface, as obtained in the conventional photographic paper, via an embossing treatment during extrusion coating of polyethylene onto the base paper.

The used amount of polyethylene on both surfaces of the paper is selected so as to optimize the layer thickness of the water based coating composition, as well as to minimize curling at low and high humidity after providing a backing layer. The thickness of the polyethylene layer on the side onto which the water based coating composition is applied in accordance with the present invention, is preferably in the range of 20-40 μm, while the thickness of the polyethylene layer on the opposite side is preferably in the 10-30 μm range.

Further, it is preferable that the polyethylene coated substrate exhibits the characteristics described below.
(1) Tensile strength: preferably 20-300 N in the longitudinal direction and 10-200 N in the lateral direction, in terms of tensile strength specified in JIS P 8113.
(2) Tear strength: preferably 0.1-2 N in the longitudinal direction and 0.2-2 N in the lateral direction in terms of the tear strength specified in JIS P 8116.
(3) Compression elasticity:≧1,030 N/cm²
(4) Bekk surface smoothness: preferably at least 500 seconds under conditions specified in JIS P 8119, however so-called embossed papers may exhibit less.
(5) Bekk rear surface smoothness: preferably 100-800 seconds under conditions specified in JIS P 8119.
(6) Opacity: preferably at most 20%, and specifically preferably no more than 15% in terms of transmittance of light in the visible region, which is determined under conditions of parallel light incidence/diffused light transmission.
(7) Whiteness: preferably at least 90% in terms of Hunter's brightness specified in JIS P 8123. Further, when measurement is carried out-utilizing JIS Z 8722 (non-fluorescent objects) and JIS Z 8717 (fluorescent objects) and the color is represented utilizing the color specification specified in JIS Z 8730, it is preferable that L*=90-98, a*=−5-+5, and b*=−10-+5.

For the purpose of enhancing adhesion onto the ink receptive layer, a subbing layer is preferably provided on the ink receiving layer side of the substrate. Binders for the subbing layer are preferably hydrophilic polymers such as gelatin, polyvinyl alcohols, and latex polymers having a Tg of −30-60° C. The binders are employed in an amount of 0.001-2 g per m² of the recording sheet. For the purpose of minimizing static charge, a small amount of antistatic agents such as cationic polymers, conventionally known in the art, may be incorporated in the subbing layer.

For the purpose of improving slippage properties as well as charging characteristics, a backing layer may also be provided on the surface opposite the ink receiving layer of the substrate. Binders for the backing layer are preferably hydrophilic polymers such as gelatin, polyvinyl alcohols, and latex polymers having a Tg of −30-60° C. Further, also incorporated may be antistatic agents such as cationic polymers, various types of surface active agents, and in addition, about 0.5-about 20 μm matting agents. The thickness of the backing layer is about 0.1-about 1 μm. However, when a backing layer is provided to minimize curling, its thickness is to be about 1-about 20 μm. Further, the backing layer may be comprised of at least two layers.

When the subbing layer, as well as the backing layer, is coated, surface treatments such as a corona treatment or a plasma treatment, applied onto the substrate surface, are preferably employed in combination.

The production method of the ink-jet recording medium of this invention is described below.

The ink-jet recording medium of this invention can be produced by the following procedure:
a layer which contains the microscopic particles and the binder containing the hydrophilic polymer compound having plural side chains on the main chain thereof and a polymerization degree of at least 300, is provided on the substrate, and
then the ionizing radiation is irradiated from a light source such as a mercury lamp or a metal halide lamp to facilitate cross linking through the side chains of the hydrophilic polymer compound to form the porous layer.

In such a production method, it is not necessary to maintain the coated layer at low temperature or to add a cross linking agent to the porous layer for setting the binder, so that the coated layer can be rapidly dried at high temperature, with reduced unevenness of the layer, such as streak coating resulting from air blow.

Subsequently, specifically preferable production methods of the ink-jet recording medium of this invention will be described.

Firstly, hydrophilic polymer compounds having plural side chains on the main chain thereof and the polymerization degree of at least 300, and another hydrophilic resin, if optional, are employed as binders, after which the binders are mixed with the microscopic particles as a filler in the presence of a surface active agent, if optional, and are then dispersed. Further, the forgoing additives are added based on need, and then an aqueous coating composition is prepared. The coating composition is applied onto at least one side of the substrate to form the porous film layer.

It is preferable that all of the porous layers are simultaneously coated from the viewpoint of reducing production cost. In this invention, it is preferable that the outermost layer contains a binder capable of cross linking by irradiation of ionizing radiation, since ink absorbability, while cracking during coating and cracking by folding are inhibited.

A coating method of the above coating composition employs a method which is appropriately selected from the several methods well known in the art. Preferably employed coating methods include, for example, a gravure coating method, a roll coating method, a rod bar coating method, an air knife coating method, a spray coating method, an extrusion coating method, a curtain coating method, or an extrusion coating method employing a hopper, described in U.S. Pat. No. 2,681,294.

Thereafter, the coated layer is irradiated by ionizing radiation of such as ultraviolet rays from a mercury lamp or a metal halide lamp. Cross linkage is formed through the side chains by irradiation of ionizing radiation so that the layer is gelled and by raising the viscosity of the coated layer inhibiting the fluid of the coated layer (being so-called “setting”). Thus a uniform coated layer can be formed. The coated layer is dried after the irradiation, thus the ink-jet recording medium on which the uniform porous layer, having the voids comprised of hydrophilic binder and microscopic particles can be obtained.

It is preferred in this invention that the coated layer is dried after ionizing radiation to evaporate the aqueous solvent, principally composed of water. A part or almost all of the solvent may have been evaporated during ionizing radiation. However, it is preferable that said ionizing radiation is applied to the coated layer in a state containing the aqueous solvent, and it is more preferable that ionizing radiation is applied just after coating. This enables promotion of cross-linking through the side chains of the hydrophilic polymer compound in the coated layer, and to dry the coated layer by inhibiting its fluidization to form a porous layer. Thus an ink-jet recording medium, having a uniform porous layer can be obtained.

Examples of ionizing radiation include electron beams, ultraviolet rays, α-rays, β-rays, γ-rays, and X-rays. Of these, preferably employed are electron beams and ultraviolet rays, which do not have adverse influence on the human body and are easily manipulated, and thus widely employed in industry.

In cases when electron beams are employed, the exposure amount of the foregoing electron beams is preferably controlled to be in the range of 0.1-20 Mrad, it is to be noted that an exposure of at least 0.1 Mrad results in desired exposure effects. An exposure amount of at most 20 Mrad is preferred because it avoids deterioration of the substrates, especially paper and certain types of plastics. Accepted as electron beam exposure systems are, for example, a scanning system, a curtain beam system, and a broad beam system. Appropriate acceleration voltage during electron beam exposure is about 100-300 kV. Incidentally, the foregoing electron beam exposure system exhibits advantages such as, compared to ultraviolet ray exposure, higher productivity can be achieved, problems such as unpleasant odor and discoloration due to the addition of sensitizing agents do not occur, and further, uniform cross-linking structures are easily achieved.

The foregoing hydrophilic polymer compounds having a polymerization degree of at least 300 and a plurality of side chains on the main chain thereof, which are preferably employed in the present invention, are sensitive to, for example, ultraviolet rays without addition of the foregoing sensitizing agents and are capable of readily undergoing a cross-linking reaction. Employed as radiation sources of the ultraviolet rays are UV lamps (e.g., low pressure, medium pressure, and high pressure mercury lamps having an operating pressure of 0.5 kPa-1 MPa), xenon lamps, tungsten lamps, and halogen lamps. The intensity of the exposed ultraviolet radiation is preferably about 5,000-about 8,000 μW/cm². Energy requirements for cross-linking through the side chains is in the range of 0.02-20 kJ/cm².

Further, when ultrviolet radiation is employed, sensitizing agents may be incorporated in the coating compositions. For example, sensitizing agents such as thioxanthone, benzoin, benzoin alkyl ether xanthone, dimethylxanthone, benzophenone, N,N,N′,N′-tetraethyl-4,4′-diaminobenzophenone, and 1,1-dichloroacetophenone may be incorporated individually or in combinations of at least two types.

Incidentally, when sensitizing agents are employed, the used amount thereof is customarily regulated to be in the range of 0.2-10 weight % with respect to the ionizing radiation curable resins in the coating composition, and preferably in the range of 0.5-5 weight %. Further, for example, tertiary amines such as triethanolamine, 2-dimethylaminoethanol, and dimethylaminobenzoic acid may be mixed in the coating compositions in an amount of 0.05-3 weight % with respect to the ionizing radiation curable resins.

Subsequently, the water-soluble dye of this invention will be described.

The water-based dye ink of this invention is characterized by containing at least water dispersible microscopic polymer particles, a water-soluble dye, water and an organic solvent.

Firstly, water dispersible microscopic polymer particles of this invention will be described.

There is specifically no limitation as usable polymers comprising water dispersible microscopic polymer particles of this invention, but listed are, for example, acryl based resins (such as acryl resins, acryl-styrene copolymers, acryl-vinyl acetate copolymers, and acryl-silicone copolymers), urethane resins, polyester resins, vinyl acetate based resins (such as vinyl acetate resins and vinyl acetate-ethylene copolymers), butadiene based resins (such as styrene-butadiene copolymers and acrylonitrile-butadiene copolymers), fluorine based resins, and polyamide based resins. Microscopic particles of these resins are usually prepared employing an emulsion polymerization method. Employed as surface active agents and polymerization initiators, which are employed in the emulsion polymerization, may be those which are employed in conventional methods. Synthesis methods of resinous micro-particles are detailed in U.S. Pat. Nos. 2,852,368, 2,853,457, 3,411,911, 3,411,912, and 4,197,127, Belgian Patent Nos. 688,882, 691,360, and 712,823, JP-B (referred to as Japanese Patent Publication) No. 45-5331, and JP-A Nos. 60-18540, 51-130217, 58-137831, and 55-50240.

In this invention, the average diameter of water dispersible polymer micro-particles is preferably 10-200 nm, and is more preferably 20-100 nm.

The average diameter of the water dispersible polymer micro-particles is easily determined employing commercially available particle size measurement apparatuses employing a light scattering system or a laser doppler system, such as Zeta Sizer 1000 (manufactured by Malvern, Inc.).

Further, in the water-soluble dye ink of the present invention, the proportion of water dispersible polymer micro-particles in the foregoing ink is preferably 0.2-10 weight %, but is more preferably 0.5-5 weight %. When the proportion of the water dispersible polymer micro-particles is at least 0.2 weight %, it is possible to effectively enhance gas fading resistance. On the other hand, it is preferably at most 10 weight % because ink ejection is more stabilized and it is possible to minimize the increase in ink viscosity during storage.

Further, in the present invention, the minimum film forming temperature (MFT) or the glass transition temperature (Tg) of the water dispersible polymer micro-particles is preferably 60° C. or less. In the present invention, in order to control the minimum film forming temperature of the water dispersible polymer micro-particles, film forming aids may be incorporated. The foregoing film forming aids are also called plasticizers which are organic compounds (commonly, organic solvents). Such compounds decrease the minimum film forming temperature of polymer latexes and are described, for example, in Soichi Muroi, “Gosei Latex no Kagaku (Chemistry of Synthesized Latexes)” (published by Kobunshi Kanko Kai, 1970).

The water-soluble dye ink of the present invention comprises at least a water-soluble dye, water, and an organic solvent, in addition to the foregoing water dispersible polymer micro-particles.

Listed as usable water-soluble dyes in the present invention may be azo dyes, methine dyes, azomethine dyes, xanthene dyes, quinone dyes, phthalocyanine dyes, triphenylmethane dyes, and diphenylmethane dyes. The specific compounds are listed below, however, the present invention is not limited to these exemplified compounds.

C.I. Acid Yellow

1, 3, 11, 17, 18, 19, 23, 25, 36, 38, 40, 42, 44, 49, 59, 61, 65, 67, 72, 73, 79, 99, 104, 110, 114, 116, 118, 121, 127, 129, 135, 137, 141, 143, 151, 155, 158, 159, 169, 176, 184, 193, 200, 204, 207, 215, 219, 220, 230, 232, 235, 241, 242, and 246

C.I. Acid Orange

3, 7, 8, 10, 19, 24, 51, 56, 67, 74, 80, 86, 87, 88, 89, 94, 95, 107, 108, 116, 122, 127, 140, 142, 144, 149, 152, 156, 162, 166, and 168

C.I. Acid Red

1, 6, 8, 9, 13, 18, 27, 35, 37, 52, 54, 57, 73, 82, 8.8, 97, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, and 415

C.I. Acid Violet

17, 19, 21, 42, 43, 47, 48, 49, 54, 66, 78, 90, 97, 102, 109, and 126

C.I. Acid Blue

1, 7, 9, 15, 23, 25, 40, 62, 72, 74, 80, 83, 90, 92, 103, 104, 112, 113, 114, 120, 127, 128, 129, 138, 140, 142, 156, 158, 171, 182, 185, 193, 199, 201, 203, 204, 205, 207, 209, 220, 221, 224, 225, 229, 230, 239, 249, 258, 260, 264, 278, 279, 280, 284, 290, 296, 298, 300, 317, 324, 333, 335, 338, 342, and 350

C.I. Acid Green

9, 12, 16, 19, 20, 25, 27, 28, 40, 43, 56, 73, 81, 84, 104, 108, and 109

C.I. Acid Brown

2, 4, 13, 14, 19, 28, 44, 123, 224, 226, 227, 248, 282, 283, 289, 294, 297, 298, 301, 355, 357, and 413

C.I. Acid Black

1, 2, 3, 24, 26, 31, 50, 52, 58, 60, 63, 107, 109, 112, 119, 132, 140, 155, 172, 187, 188, 194, 207, and 222

C.I. Direct Yellow

8, 9, 10, 11, 12, 22, 27, 28, 39, 44, 50, 58, 86, 87, 98, 105, 106, 130, 132, 137, 142, 147, and 153

C.I. Direct Orange

6, 26, 27, 34, 39, 40, 46, 102, 105, 107, and 118

C.I. Direct Red

2, 4, 9, 23, 24, 31, 54, 62, 69, 79, 80, 81, 83, 84, 89, 95, 212, 224, 225, 226, 227, 239, 242, 243, and 254

C.I. Direct Violet

9, 35, 51, 66, 94, and 95

C.I. Direct Blue

1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290, and 291

C.I. Direct Green

26, 28, 59, 80, and 85

C.I. Direct Brown

44, 106, 115, 195, 209, 210, 222, and 223

C.I. Direct Black

17, 19, 22, 32, 51, 62, 108, 112, 113, 117, 118, 132, 146, 154, 159, and 169

C.I. Basic Yellow

1, 2, 11, 13, 15, 19, 21, 28, 29, 32, 36, 40, 41, 45, 51, 63, 67, 70, 73, and 91

C.I. Basic Orange

2, 21, and 22

C.I. Basic Red

1, 2, 12, 13, 14, 15, 18, 23, 24, 27, 29, 35, 36, 39, 46, 51, 52, 69, 70, 73, 82, and 109

C.I. Basic Violet

1, 3, 7, 10, 11, 15, 16, 21, 27, and 39

C.I. Basic Blue

1, 3, 7, 9, 21, 22, 26, 41, 45, 47, 52, 54, 65, 69, 75, 77, 92, 100, 105, 117, 124, 129, 147, and 151

C.I. Basic Green

1, and 4

C.I. Basic Brown

1

C.I. Reactive Yellow

2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175, and 176

C.I. Reactive Orange

1, 4, 5, 7, 11, 12, 13, 15, 16, 20, 30, 35, 56, 64, 67, 69, 70, 72, 74, 82, 84, 86, 87, 91, 92, 93, 95, and 107

C.I. Reactive Red

2, 3, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 228, and 235

C.I. Reactive Violet

1, 2, 4, 5, 6, 22, 23, 33, 36, and 38

C.I. Reactive Blue

2, 3, 4, 5, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235, and 236

C.I. Reactive Green

8, 12, 15, 19, and 21

C.I. Reactive Brown

2, 7, 9, 10, 11, 17, 18, 19, 21, 23, 31, 37, 43, and 46

C.I. Reactive Black

5, 8, 13, 14, 31, 34, and 39

These dyes listed above are disclosed in “Sensyoku Notes, 21^{st} edition, published by Sikisensya)

Of these water-soluble dyes, preferable are phthalocyanine dyes.

As examples of phthalocyanine dyes, listed are those with no substituent or with a central atom in the molecule. The central atoms in the molecule may be metals or non-metals. The preferred atom is copper, while the preferred dye is C.I. Direct Blue 199.

Organic solvents usable in the present invention are not specially limited, but water-soluble organic solvents are preferable. Specific examples of the water-soluble solvents include alcohols such as methanol, ethanol, propanol, isopropanol, butanol, isobutanol, secondary butanol, tertiary butanol, pentanol, hexanol, cyclohexanol and benzyl alcohol; polyhydric alcohols such as ethylene glycol, diethylene glycol, triethylene glycol, polyethylene glycol, propylene glycol, dipropylene glycol, polypropylene glycol, butylene glycol, hexanediol, pentanediol, glycerine, hexanetriol and thiodiglycol; polyhydric alcohol ethers such as ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monobutyl ether, diethylene glycol dimethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, triethylene glycol monobutyl ether, triethylene glycol dimethyl ether, dipropylene glycol monopropyl ether, and tripropylene glycol diethyl ether; amines such as ethanolamine, diethanol amine, triethanolamine, N-methyldiethanol amine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine and tetramethylpropylenediamine; amides such as formamide, N,N-dimethylformamide and N,N-dimethylacetoamide; heterocyclic compounds such as 2-pyrrolidone, N-methyl-2-pyrrolidone, N-cyclohexyl-2-pyrrolidone, 2-oxazolidone and 1,3-dimethyl-2-imidazolidinone; sulfoxides such as dimethylsuofoxide; sulfones such as sulfolane; sulfonates such as sodium 1-butanesulfonate; urea; acetonitrile and acetone.

In the water-soluble dye ink of this invention, various types of surface active agents may be employed. Surface active agents usable in the present invention are not particularly limited. Examples include anionic surface active agents such as dialkylsulfosuccinates, alkylnaphthalenesulfonates, and fatty acid salts; nonionic surface active agents such as polyoxyethylene alkyl ethers, polyoxyethylene alkyl allyl ethers, acetylene glycols, and polyoxyethylene-polyoxypropylene block copolymers; and cationic surface active agents such as alkylamines and quaternary ammonium salts. Of these, particularly preferably employed are anionic surface active agents as well as nonionic surface active agents.

Further, in the water-soluble dye ink of the present invention, employed may be higher molecular surface active agents. Listed as such surface active agents may be, for example, styrene-acrylic acid-acrylic acid alkylester copolymers, styrene-acrylic acid copolymers, styrene-maleic acid-acrylic acid alkylester copolymers, styrene-maleic acid copolymers, styrene-methacrylic acid-acrylic acid alkylester copolymers, styrene-methacrylic acid copolymers, styrene-maleic acid half ester copolymers, vinylnaphthalene-acrylic acid copolymers, and vinylnaphthalene-maleic acid copolymers.

In the water-soluble dye ink of this invention, other than those described above, if desired, to achieve enhancement of ejection stability, adaptability to the ink head and ink cartridge, storage stability, image retention properties, and other desired performance, appropriately selected and employed may be various prior art additives such as viscosity modifiers, specific resistance controlling agents, film forming agents, UV absorbing agents, antioxidants, anti-fading agents, fungicides, and rust-preventing agents. Further listed my be liquid paraffin, dioctyl phthalate, tricresyl phosphate, minute oil droplets such as silicone oil, UV absorbing agents described in JP-A Nos. 57-74193, 57-87988, and 62-261476, anti-fading agents described in JP-A Nos. 57-74192, 57-87989, 60-72785, 61-146591, 1-95091, and 3-13376, and fluorescent brightening agents described in JP-A Nos. 59-42993, 59-52689, 62-280069, 61-242871, and 4-219266.

An ink-jet head employed in the ink-jet recording method of the present invention may be structured by employing either an on-demand system or a continuous system specific examples of the ejection system include an electro-mechanical conversion system (e.g., a single cavity type, a double cavity type, a vendor type, a piston type, a share mode type, and a shared wall type), an electric-heat conversion system [e.g., a thermal ink jet type and a Bubble Jet (R) type]], an electrostatic attraction system (e.g., an electric field control type and a slit jet type), as well as a discharge system (e.g., a spark jet type). Any of these may be employed in the present invention.

### EXAMPLES

The present invention will now be specifically described with reference to examples. However, the present invention is not limited thereto. In the Examples, “%” indicates weight %, unless otherwise noted.

### Example 1

Preparation of Recording Medium 1

Preparation of Silica Dispersion D1

While stirring at 3,000 rμm at room temperature, added to 110 L of aqueous solution C1 (pH=2.5, containing 2 g of antifoaming agent SN381 manufactured by Sun Nopco Ltd.) containing 12% of cationic polymer (P-A), 10% of n-propanol, and 2% of ethanol, was 400 L of silica dispersion Bl (pH=2.4, containing 1% of ethanol) containing 25% of gas phase method silica of an average diameter of 0.012 μm, which had been uniformly dispersed, and 0.3% of water-soluble fluorescent brightening agent Uvitex NFW Liquid (manufactured by Ciba Specialty Chemicals). Subsequently, while stirring at 3,000 rpm, 54 L of a mixed aqueous solution Al containing boric acid and borax at the weight ratio of 1:1 (concentration of 3% for each) was gradually added to the resulting mixture at room temperature.

Subsequently, the resulting mixture was dispersed under a pressure of 3 kN/cm², employing a high pressure homogenizer manufactured by Sanwa Kogyo Co., Ltd., the total volume of which was brought to 630 L by addition of pure water, whereby nearly transparent Silica Dispersion D1 was prepared.

Silica Dispersion D1 above was filtered employing a TCP-30 Type filter with a filtration accuracy of 30 μm, manufactured by Advantex Toyo Kaisha, Ltd.

Preparation of Silica Dispersion D2

While stirring at 3,000 rpm at room temperature, 400 L of foregoing Silica Dispersion B1 was added to 120 L of aqueous solution C2 (at a pH of 2.5) containing 12% of a cationic polymer (P-2), 10% of n-propanol, and 2% of ethanol. Subsequently, while stirring, 52 L of foregoing mixed aqueous solution A1 was gradually added.

Subsequently, the resulting mixture was dispersed under a pressure of 3 kN/cm², employing a high pressure homogenizer, manufactured by Sanwa Industries Co., Ltd., the total volume of which was then brought to 630 L by addition of pure water, whereby almost transparent Silica Dispersion D2 was prepared.

Foregoing Silica Dispersion D2 was filtered employing TCP-30 Type filter with a filtering accuracy of 30 μm, manufactured by Advantech Toyo Kaisha, Ltd.

Preparation of Oil Dispersion

Under elevated temperature, dissolved in 45 kg of ethyl acetate were 120 kg of diisodecyl phthalate and 20 kg of an antioxidant (AO-1), the resulting solution of which was mixed at 55° C. with 210 L of an aqueous gelatin solution containing 8 kg of acid process gelatin, 2.9 kg of cationic polymer (P-1), and 10.5 kg of saponin. Subsequently, the resulting mixture was emulsify-dispersed employing a high pressure homogenizer, after which the total volume of the resulting dispersion was brought to 300 L by addition of pure water, whereby an oil dispersion was prepared.

Cationic polymer (P-1) 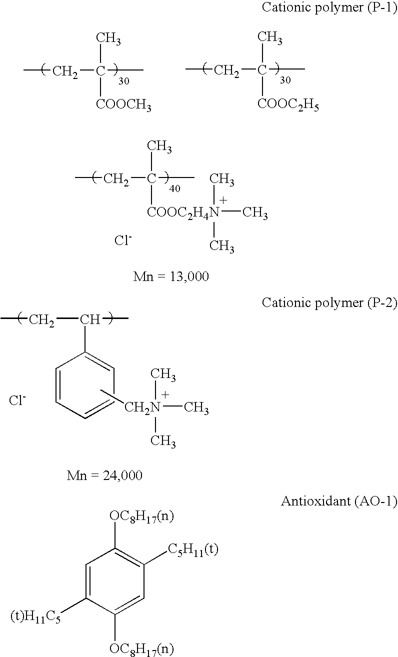
Preparation of Coating Compositions

Each of the additives described below was successively added to each respectively dispersion prepared above, whereby a coating composition was prepared. Incidentally, the volume of each additive is expressed per L.

First Layer Coating Composition: Lowermost Layer

| | |
|---|---|
| Silica Dispersion D1 | 589 ml |
| Polyvinyl alcohol, being a 6.5% aqueous solution | 290 ml |
| (at an average polymerization degree of 2,300, | |
| and a saponification ratio of 88%) | |
| Oil Dispersion | 30 ml |
| Latex dispersion (AE803, manufactured by | 42 ml |
| Showa Highpolymer Co., Ltd.) | |
| Ethanol | 8.5 ml |
| Water to make | 1,000 ml |

Second Layer Coating Composition)

| | |
|---|---|
| Silica Dispersion D1 | 548 ml |
| Polyvinyl alcohol, being a 6.5% aqueous solution | 270 ml |
| (at an average polymerization degree of 2,300 | |
| and a saponification ratio of 88%) | |
| Oil Dispersion | 20 ml |
| Latex dispersion (AE803, manufactured by | 22 ml |
| Showa Polymer Co., Ltd.) | |
| Ethanol | 8 ml |
| Pure water to make | 1,000 ml |

Third Layer Coating Composition

| | |
|---|---|
| Silica Dispersion D2 | 548 ml |
| Polyvinyl alcohol, being a 6.5% aqueous solution | 135 ml |
| (at an average polymerization degree of 2,300 | |
| and a saponification ratio of 88%) | |
| Oil Dispersion | 10 ml |
| Latex dispersion (AE803, manufactured by | 5 ml |
| Showa Polymer Co., Ltd.) | |
| Ethanol | 3 ml |
| Pure water to make | 1,000 ml |

Fourth Layer Coating Composition: Uppermost layer

| | |
|---|---|
| Silica Dispersion D2 | 548 ml |
| Polyvinyl alcohol, being a 6.5% aqueous solution | 135 ml |
| (at an average polymerization degree of 2,300 | |
| and a saponification ratio of 88%) | |
| Betaine Type Surface Active Agent-1, | 3 ml |
| being a 4% aqueous solution | |
| Saponin, being a 25% aqueous solution | 2 ml |
| Pure water to make | 1,000 ml |

Betaine Type Surface Active Agent-1

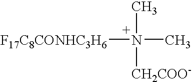

Each coating composition prepared above was filtered using a TCPD-30 Type filter with a filtration accuracy of 20 μm, manufactured by Advantex Toyo Kaisha, Ltd., after which the resulting filtrate was again filtered using a TCPD-10 Type filter.

Coating

Subsequently, the foregoing four coating compositions were simultaneously applied at 40° C. onto a RC substrate coated with polyethylene on both sides, employing a slide hopper type coater to result in the wet layer thickness described below.

Wet Layer Thickness

First Layer: 42 μm

Second Layer: 39 μm

Third Layer: 44 μm

Fourth Layer: 38 μm

Incidentally, the RC substrate employed above, was prepared as follows. Polyethylene containing anatase type titanium oxide in an amount of 6% was melt-extruded and applied onto the surface of photographic base paper of a basis weight of 170 g and a moisture content of 8%, to result in a polyethylene thickness of 35 μm, while polyethylene was melt-extruded and applied onto the rear surface to result in a thickness of 40 μm. The front surface was subjected to corona discharge. Thereafter, polyvinyl alcohol (PVA235, manufactured by Kuraray Co., Ltd.) was applied onto the resulting surface to result in a coated weight of 0.05 g/m² of the recording medium, whereby a subbing layer was formed. Subsequently, the rear was also subjected to corona discharge. Thereafter, onto the resulting surface was applied a backing layer containing approximately 0.4 g of a styrene-acrylic acid ester based latex binder, 0.1 g of an antistatic agent (being a cationic polymer), and 0.1 g of silica of approximately 2 μm particles as a matting agent.

After coating of the coating composition for the ink absorbing layer, the resulting coating passed trough a cooling zone maintained at 5° C. over 15 seconds to lower the layer surface temperature to 13° C. Thereafter, the coating was dried in a plurality of drying zones in which the temperature was suitably set and was wound onto a roll, whereby Recording Medium 101 was prepared.

Recording Medium 102 was prepared in the same manner as foregoing Recording Medium 101, except that the fourth layer differed as below.

Coating Composition for the Fourth Layer

| | |
|---|---|
| Cationic Colloidal Silica (being Snowtex AK-L, | 750 ml |
| Produced by Nissan Chemical Industries, Ltd. | |
| Polyvinyl alcohol, being a 6.5% aqueous solution | 231 ml |
| (at an average polymerization degree of 2,300, | |
| and a saponification rate of 88%) | |
| Betaine Type Surface Active Agent-1, | 3 ml |
| being a 4% aqueous solution | |
| Saponin, being a 25% aqueous solution | 2 ml |
| Pure water to make | 1,000 ml |

Subsequently, after the first through the third layers of Recording Medium 102 were coated and dried, the fourth layer was applied to prepare Recording Medium 103.

Next, Silica Dispersion D3 was prepared in the same manner as foregoing Silica Dispersion D1, except that no mixed aqueous solution Al containing boric acid and borax was added, and Silica Dispersion D4 was prepared in the same manner as foregoing Silica Dispersion D2, except that no mixed aqueous solution Al containing boric acid and borax was added. While stirring an electron ray polymerizable compound (being NK ester A-TMM-3, produced by Shin-Nakamura Chemical Co., Ltd.), D3 or D4 was gradually added so as to obtain a weight ratio of solid content of the gas phase method silica vs. the electron ray polymerizable compound being 2.5:1, to prepare the coating compositions used for the first through the third layers. Subsequently, the coating composition for the fourth layer of Recording Medium 104 was prepared so as to obtain the ratio of the anionic colloidal silica (being Snowtex OL, produced by Nissan Chemical Industries, Ltd.), instead of the foregoing gas phase method silica, vs. the foregoing electron ray polymerizable compound, being 2.5:1.

Employing the same substrate of Recording Media 101-103, these coating compositions of the first through the fourth layer were applied onto the substrate with a multilayer simultaneous coating method, at the same layer thickness as Recording Medium 103, after which electron rays at an acceleration voltage of 200 kV and irradiation amount of 4 Mrad were irradiated to prepare Recording Medium 104.

Recording Medium 105 was prepared, only differing from Recording Medium 104, in that the fourth layer was coated and cured after the first-third layers were coated and cured.

Recording Medium 106 was prepared in the same manner as Recording Medium 104, except that the ratio of the gas phase method silica vs. electron ray polymerizable compound in the first through the third layer was 5:1 and the colloidal silica in the fourth layer was replaced by cationic silica (being Snowtex AK-L, produced by Nissan Chemical Industries, Ltd.), and further the ratio of the colloidal silica vs. the electron ray polymerizable compound was 5:1.

Recording Medium 107 was prepared in the same manner as Recording Medium 106, except that the fourth layer was coated and cured only after the first through the third layers were coated and cured.

Next, Recording Medium 108 was prepared in the same manner as Recording Medium 102, except that preparation of the coating composition for the fourth layer was changed as follows.

To cationic colloidal silica (being Snowtex AK-L, produced by Nissan Chemical Industries, Ltd.), gradually added while stirring was a photo cross-linkable polyvinyl alcohol derivative aqueous solution in which a stilbazolinium group was introduced and the content of the polyvinyl alcohol was adjusted to 10% (being SPP-SHR, a main chain of PVA, a polymerization degree of 2,300, and a saponification ratio of 88%, produced by Toyo Gosei Co., Ltd.), so as to reach the solid weight ratio of the colloidal silica vs. PVA being 10:1, to prepare the fourth layer coating composition.

The first-third layer coating compositions employed to prepare Recording Medium 102 and the foregoing fourth layer coating composition were coated with a simultaneous multilayer coating method so that the total coated thichness reached 180 μm, after which the coated layers were dried under the same conditions as those for Recording Medium 101. Then, the coating was irradiated under UV light of 2 kJ/cm² employing a metal halide lamp having a dominant wavelength of 360 nm, after which it dried at 80° C. in a hot air oven, to obtain a recording medium having porous layers.

Next, Recording Medium 109 was prepared in the same manner as Recording Medium 108, except that the binder used in the first-third layers was changed from normal PVA to the foregoing photo cross-linkable polyvinyl alcohol, and the solid weight ratio of added silica vs. polyvinyl alcohol was adjusted to 10:1, after which it was irradiated under UV light of 2 kJ/cm² employing a metal halide lamp having a dominant wavelength of 360 nm, and dried at 80° C. in a hot air oven.

Subsequently, Recording Media 110 and 111 were prepared in the same manner as Recording Medium 109, except that the solid weight ratio of the gas phase method silica and the colloidal silica vs the photo polymerizable polyvinyl alcohol in the first through the fourth layer was changed to 25:1 in the case of Recording Medium 110, and to 35:1 in the case of Recording Medium 111.

The first layers and the fourth layers of Recording Media 101-111 and the respective coating methods are shown in Table 1.

TABLE 1

| | The fourth layer | | | | | | | | | |
|---|---|---|---|---|---|---|---|---|---|---|
| | (the outermost layer) | | | | The 1^{st}-3^{rd} layer | | | | | |
| Recording | | Polym- | | Inorganic | | Polym- | | Inorganic | | |
| Medium | Binder | erization | | micro- | Binder | erization | | micro- | Coating | |
| No. | (kind) | degree | F/B | particles | (kind) | degree | F/B | particles | method | Remarks |
| 101 | PVA | 2300 | 10 | Gas phase | PVA | 2300 | 5 | Gas phase | Simultaneous | Comp. |
| | | | | method | | | | method | | |
| | | | | silica | | | | silica | | |
| 102 | PVA | 2300 | 10 | Cationic | PVA | 2300 | 5 | Gas phase | Simultaneous | Comp. |
| | | | | colloidal | | | | method | | |
| | | | | silica | | | | silica | | |
| 103 | PVA | 2300 | 10 | Cationic | PVA | 2300 | 5 | Gas phase | Sequential | Comp. |
| | | | | colloidal | | | | method | | |
| | | | | silica | | | | silica | | |
| 104 | Electron | — | 2.5 | Anionic | Electron ray | — | 2.5 | Gas phase | Simultaneous | Comp. |
| | ray curable | | | colloidal | curable | | | method | | |
| | compound | | | silica | compound | | | silica | | |
| 105 | Electron | — | 2.5 | Anionic | Electron ray | — | 2.5 | Gas phase | Sequential | Comp. |
| | ray curable | | | colloidal | curable | — | | method | | |
| | compound | | | silica | compound | | | silica | | |
| 106 | Electron | — | 5 | Cationic | Electron ray | — | 5 | Gas phase | Simultaneous | Comp. |
| | ray curable | | | colloidal | curable | | | method | | |
| | compound | | | silica | compound | | | silica | | |
| 107 | Electron | — | 5 | Cationic | Electron ray | — | 5 | Gas phase | Sequential | Comp. |
| | ray curable | | | colloidal | curable | | | method | | |
| | compound | | | silica | compound | | | silica | | |
| 108 | PVA | 2300 | 10 | Cationic | PVA | 2300 | 5 | Gas phase | Simultaneous | Inv. |
| | derivative | | | colloidal | | | | method | | |
| | | | | silica | | | | silica | | |
| 109 | PVA | 2300 | 10 | Cationic | PVA | 2300 | 10 | Gas phase | Simultaneous | Inv. |
| | derivative | | | colloidal | derivative | | | method | | |
| | | | | silica | | | | silica | | |
| 110 | PVA | 2300 | 25 | Cationic | PVA | 2300 | 25 | Gas phase | Simultaneous | Inv. |
| | derivative | | | colloidol | derivative | | | method | | |
| | | | | silica | | | | silica | | |
| 111 | PVA | 2300 | 35 | Cationic | PVA | 2300 | 35 | Gas phase | Simultaneous | Inv. |
| | derivative | | | colloidol | derivative | | | method | | |
| | | | | silica | | | | silica | | |

F/B: Inorganic micro-particles/Binder
Note:
Comp.: Comparative example
Inv.: This invention

Evaluation of Recording Medium

These recording media were evaluated for the following characteristics, the results of which are listed in Table 2.

Cracking During Coating Operation

The number of cracks in 10 cm² of each Recording Medium was determined and divided into the four ranks as follows.

A: No cracks were observed.

B: Number of cracks was 1-3.

C: Number of cracks was 4-7.

D: Number of cracks was 8 or more.

Cracking by Folding

The recording medium was cut into rectangles of 5×10 cm, wound on a paper tube with an exterior diameter of 3 cm, and any formed cracks were visually evaluated into these five ranks.

A: No cracks were observed.

B: Five or fewer cracks were observed.

C: 6-20 cracks were observed.

D: 21-100 cracks were observed.

E: More than 101 cracks were observed.

Ink Absorbability

Preparation of Dye Ink 1

Dye Ink 1 was prepared as follows:

| | |
|---|---|
| C.I. Direct Blue 199 | 3 weight % |
| Diethylene glycol | 25 weight % |
| Dioctyl sodium sulfosuccinate | 0.01 weight % |
| Water to make | 100 weight % |

As a printer, MJ 800C, manufactured by Seiko Epson Corp. was employed, and Dye Ink 1 prepared as above was used to fill the ink cartridge provided with the printer, after which a solid color image was printed on the recording medium at an ejected amount of 10 ml/m². Ten seconds after printing, a sheet of plain paper was pressed onto the printed area of the recording medium to visually evaluate ink transfer and classify the ink transfer into the following four ranks.

A: No ink-offset was observed.

B: Slight ink-offset was observed, but not also problem from a practical viewpoint.

C: Noticeable ink-offset was observed.

D: Severe ink-offset was observed.

Glossiness of White Background

Glossiness of white background of the recording medium was visually evaluated based on the following four ranks.

A: Glossiness was equivalent to that of silver salt photography.

B: Glossiness was close to that of silver salt photography.

C: Glossiness was apparently inferior to that of silver salt photography.

D: Glossiness was obviously lower than that of silver salt photography.

TABLE 2

| | | | | | Glossiness | |
|---|---|---|---|---|---|---|
| Recording | | | Cracking | Cracking | of | |
| medium | Kind of | | during | by | white | |
| No. | ink | Absorbability | coating | folding | background | Remarks |
| 101 | *1 | C | C | D | D | Comp. |
| 102 | *1 | C | D | D | C | Comp. |
| 103 | *1 | C | C | D | B | Comp. |
| 104 | *1 | D | D | D | D | Comp. |
| 105 | *1 | D | C | D | B | Comp. |
| 106 | *1 | C | D | C | B | Comp. |
| 107 | *1 | C | C | C | B | Comp. |
| 108 | *1 | B | B | B | B | Inv. |
| 109 | *1 | A | A | A | B | Inv. |
| 110 | *1 | A | A | A | B | Inv. |
| 111 | *1 | A | B | B | B | Inv. |

*1: Dye ink 1 (without water dispersible polymer micro-particles)

Recording Medium 102, the outermost layer of which was changed to contain a cationic colloidal silica exhibited an enhanced effect for glossiness of white background, but inferior in cracking resistance during coating and resistance to cracking by folding, compared to Recording Medium 101. Recording Medium 103, the outermost layer of which was sequentially coated exhibited improved resistance to cracking during coating and an enhanced effect of glossiness of white background, but the productivity was unacceptably low.

Correspondingly, Recording Medium 104 in which the binder was changed from polyvinyl alcohol to an electron ray polymerizable compound, and from a colloidal silica to an anionic colloidal silica, whereby aggregation on coating surface was generated to result in reduced surface smoothness and lowered glossiness, because the ink absorbing layer was cationic when the surface layer was coated simultaneously with the ink absorbing layer. On the other hand, Recording Media 105-107 in which silica was changed to a cationic colloidal silica exhibited an enhanced resistance to cracking by folding and enhanced glossiness of white background, but tended to degrade ink absorbability and increased cracking during coating. Compared to these, Recording Media 108-111 in which the binder was changed to photo cross-likable PVA, were superior in all of ink absorbability, cracking resistance during coating, cracking resistance by folding, and glossiness of white background, whereby improved effects of this invention were confirmed.

### Example 2

Using Recording Media 101-111 prepared in Example 1, printed samples as in Example 1 were prepared, using Dye Ink 2 in which the following water dispersible polymer micro-particles were added to Dye Ink 1 so that the polymer became 1% of the solid content of the dye. In addition, using Recording Medium 109, printed samples were prepared employing Dye Inks 3-5 which were prepared to contain the following water dispersible polymer micro-particles respectively. Further, the water dispersible polymer micro-particles were added until the solid content of the dye become 1%, the same as in Dye Ink 2.

Dye Ink 2: Water dispersible polymer micro-particles: Nonionic urethane resin (being Superflex 500, at MFT of 5° C., and an average particle diameter of 140 nm, produced by Dai-Ichi Kogyo Seiyaku Co., Ltd.)

Dye Ink 3: Water dispersible polymer micro-particles: LX-531B (featuring a Tg of −12° C. and an average particle diameter of 300 nm, produced by Zeon Corp.)

Dye Ink 4: Water dispersible polymer micro-particles: SX-1503 (featuring a Tg of −20° C., and an average particle diameter of 50 nm, produced by Zeon Corp.)

Dye Ink 5: Water dispersible polymer micro-particles: UWS-145 (featuring a Tg of −50° C. and an average particle diameter of less than 10 nm, produced by Sanyo Chemical Industries, Ltd.)

Evaluation was conducted for the following characteristics, the results of which are shown in Table 3.

Glossiness Difference

Glossiness difference between the printed areas and the unprinted areas in the print was visually evaluated into the following ranks.

A: Glossiness in both the printed and unprinted areas was very high, so that no glossiness differences were noted.

B: Glossiness in the printed and unprinted areas was high, and although glossiness difference was noteed but it caused no concerned.

C: Glossiness differences between the printed areas and unprinted areas were apparent, and unacceptable.

D: Glossiness differences between the printed and unprinted areas were obvious.

Resistance to Rubbing

The printed area of the image was rubbed 10 times using tissue paper, after which the surface was visually observed and evaluated into the following four ranks.

A: No damage nor layer peeling was observed.

B: Slight damage was observed, but within acceptable limits.

C: Damage and layer peeling were obvious.

D: Damage and layer peeling were excessive.

Image Storage Stability

Printed images were placed in an ambience of an ozone concentration of 50 pμm at 23° C. for 120 minutes, after which reflecting density prior to and after exposure to ozone was determined under red monochromatic light, employing an optical densitometer (X-Rite 938, manufactured by X-Rite Inc.), after which a residual image ratio was obtained based on the formula listed below. Image Storage Stability was then evaluated into the four ranks based on the criteria below.

Image residual ratio=(1−reflecting density after exposure/reflecting density prior to exposure)×100%)

A: The image residual ratio was more than 95%.

B: The image residual ratio was between 80-95%.

C: The image residual ratio was between 65-79%.

D: The Image residual ration was less than 65%.

TABLE 3

| | | | Resistance | | |
|---|---|---|---|---|---|
| | | | to | | |
| Recording | | | peeling | Image | |
| medium | | Glossiness | by | storage | |
| No. | Kind of ink | difference | rubbing | stability | Remarks |
| 101 | *1 | D | C | D | Comp. |
| 102 | *1 | C | D | D | Comp. |
| 103 | *1 | C | C | B | Comp. |
| 104 | *1 | D | D | C | Comp. |
| 105 | *1 | D | D | C | Comp. |
| 106 | *1 | B | C | B | Comp. |
| 107 | *1 | B | C | C | Comp. |
| 108 | *1 | A | B | B | Inv. |
| 109 | *1 | A | A | A | Inv. |
| 110 | *1 | A | B | A | Inv. |
| 111 | *1 | A | B | A | Inv. |
| 109 | *2 | B | B | B | Inv. |
| 109 | *3 | A | B | A | Inv. |
| 109 | *4 | A | A | A | Inv. |

*1: Dye Ink 2(dye + water dispersible polymer micro-particles)
*2: Dye Ink 3 (dye + water dispersible polymer micro-particles)
*3: Dye Ink 4 (dye + water dispersible polymer micro-particles)
*4: Dye Ink 5 (dye + water dispersible polymer micro-particles)

Recording Medium 101, all layers of which were composed Chiefly of a gas phase method silica, was deteriorated in glossiness difference and much degraded in image storage stability. In Recording Medium 102 in which the surface layer was changed to a colloidal silica, glossiness difference was slightly improved but not sufficiently. In Recording Medium 103 in which the colloidal silica layer was sequentially coated, all evaluation factors tended to be improved, but still further improvements were desired. In Recording Media 104-107 in which the binder was changed to the electron ray polymerizable compound, any improvement effects were insufficient.

However, in Recording Media 108-111 in which the binder was changed to the photo cross-linkable polyvinyl alcohol, enhanced effects of glossiness difference between the printed areas and the unprinted areas, resistance to peeling by rubbing, and image storage stability, was observed. Further, when Recording Medium 109 was employed and Dye Inks 3-5 which contained water dispersible polymer micro-particles were employed, the desired improvement effects of glossiness difference, resistance to peeling by rubbing and image storage stability were obtained.

1. An ink-jet recording medium comprising:
(i) a non water-absorbing substrate;
(ii) one or more ink receiving layers provided on the substrate; and
(iii) a surface layer provided on the ink receiving layer;
wherein the ink receiving layer is a porous layer containing a cross-linked polymer as a binder formed by irradiation of ionizing radiation to a hydrophilic polymer having a polymerization degree of at least 300 and a plurality of side chains on a main chain so as to cross-link the hydrophilic polymer through side chains; and the surface layer is a porous layer containing the cross-linked polymer as a binder and a cationic colloidal silica.

2. The ink-jet recording medium of claim 1, wherein the ink receiving layer further contains inorganic pigment microparticles, and a weight ratio of inorganic pigment microparticles to the binder, both being contained in the ink receiving layer, is in the range of 3:1 to 30:1.

3. The ink-jet recording medium of claim 1, wherein a weight ratio of the cationic colloidal silica to the binder, both being contained in the surface layer is in the range of 3:1 to 30:1.

4. A production method of an ink-jet recording medium comprising the steps of:
(i) providing on a non water-absorbing substrate, one or more ink receiving layers containing a cross-linked polymer formed by irradiation of ionizing radiation to a hydrophilic polymer compound which has a polymerization degree of at least 300 and a plurality of side chains on a main chain so as to cross-link through the side chains; and
(ii) providing a surface layer containing a cationic colloidal silica on the ink receiving layers;
wherein a coating composition of the ink receiving layer adjacent to the surface layer contains a gas phase method silica; and
the one or more ink receiving layers and the surface layer are provided using a simultaneous multilayer coating method.

5. The production method of the ink-jet recording medium of claim 4, wherein a weight ratio of inorganic pigment microparticles to the binder, both being contained in the ink receiving layer, is in the range of 3:1 to 30:1.

6. The production method of an ink-jet recording medium of claim 4, wherein a weight ratio of the cationic colloidal silica to the binder, both being contained in the surface layer, is in the range of 3:1 to 30:1.

7. An ink-jet image forming method comprising the step of:
recording an ink-jet image onto the ink-jet recording medium of claim 1, using a water-soluble dye ink which contains microscopic water dispersible polymer particles.
